(19) United States
(12) Patent Application Publication
(10) Pub. No.: US 2007/0112667 A1
(43) Pub. Date: May 17, 2007

(54) System and method for providing a fraud risk score

(75) Inventor: Daniel Vincent Rucker, Bethlehem, PA (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Dun and Bradstreet

(21) Appl. No.: 11/589,661

(22) Filed: Oct. 30, 2006

Related U.S. Application Data
(60) Provisional application No. 60/731,823, filed on Oct. 31, 2005.

(51) Int. Cl. G06Q 40/00

(52) U.S. Cl. 705/38

(57) ABSTRACT

A computer-implemented method for providing a predictive measure of fraud risk. The method includes receiving applicant identification data, identifying predictive fraud patterns by matching the applicant identification data to a historical search database, calculating a predictive measure of fraud risk using the predictive fraud patterns; and providing the predictive measure of fraud risk to a user.

### CROSS REFERENCE TO RELATED APPLICATION

This application claims priority in copending U.S. Provisional Application Ser. No. 60/731,823, filed Oct. 31, 2005, the disclosure of which is incorporated in its entirety herein by reference.

### BACKGROUND

1. Field of the Invention

The invention relates to a method for providing an indication of fraud risk for an applicant. More particularly, the invention relates to a method for providing a fraud risk score to a user by matching applicant identification data to a historical search database.

2. Description of the Related Art

With over 92% of all businesses classified as small, the small business market offers high potential for revenue growth and profitability. However, the process of capturing this potential growth can lead to losses due to fraudulent transactions with new and unproven applicants.

As a result, many companies have increasingly been impacted by fraud due to the ways they attract new customers and make decisions about doing business with them:
Competition for new customers has intensified.
More aggressive direct marketing efforts via telephone, direct mail and web lead to new applicants with no prior relationship.
Faster credit decisions and tighter margins put pressure on credit extenders to streamline processes and increase automated decisions.

The use of deception or misrepresentation to acquire an asset or service with no intent to pay for the asset or service is a serious problem. It is estimated that 15-30% of all commercial credit losses are due to fraudulent activity and the total amount of annual fraud losses due to credit extended to commercial businesses is in excess of $20 billion. Of this $20 billion, $11 billion has been attributed to fraud associated with the original credit decision and application process.

There is a need to provide a system and method that allows a business to protect itself while preserving its ability to make fast decisions about new customers and avoid inadvertently declining offers to legitimate customers.

There is a need to provide effective tools to help users detect and prevent small business fraud. Particularly, there is a need to provide predictive data and innovative solutions to combat commercial fraud, and to address fraud concerns at all stages of the customer lifecycle.

### SUMMARY

A system and method for providing a fraud risk score, which is a predictive score that helps credit issuers and other business entities seamlessly assess fraud risk at the point of origin or new application. The fraud risk score is an early warning fraud risk screening capability. The system uses searches made to business information providers' databases to track patterns and flag data inconsistencies.

One embodiment is a computer-implemented method for providing a predictive measure of fraud risk. The method includes receiving identification data for an applicant; identifying predictive fraud patterns by matching the identification data to a historical search database; matching the identification data to a database of prior business misrepresentations; matching the identification data to a source of high risk identifiers; calculating a predictive measure of fraud risk based on the predictive fraud patterns, the degree of match between the identification data and the database of prior business misrepresentations, and the degree of match between the identification data and the source of high risk identifiers; and providing the predictive measure of fraud risk to a user.

### BRIEF DESCRIPTION OF THE DRAWINGS

FIG. 1 is a representation of the data integration quality assurance process.

FIG. 2 is a diagram of a search history.

FIG. 3 is a table showing fraud incidents among entities, as compared to their assigned fraud risk scores.

FIG. 4 is a graph showing the results of a fraud risk score validation sample.

FIG. 5 is a block diagram demonstrating the integration of the fraud risk score process in a data matching/validation system.

FIG. 6 is an illustration of a portion of a fraud risk score report showing a fraud risk score summary.

FIG. 7 is an illustration of a portion of a fraud risk score report showing fraud risk indicators and historical search data.

FIG. 8 is an illustration of a portion of a fraud risk score report showing a high risk misrepresentation match.

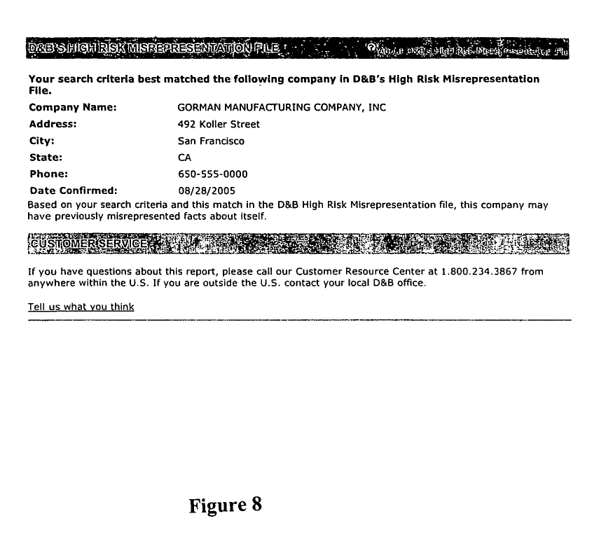

### DESCRIPTION OF THE INVENTION

The present disclosure provides a fraud risk score (FRS), which is a predictive score that helps credit issuers easily assess fraud risk at the point of origination or new application. The fraud risk score is an early-warning fraud risk screening capability. At the core of the score model is the massive amount of business searches made every day to business information providers. Companies use these searches to track patterns and flag data inconsistencies that have previously identified fraudulent businesses. Using the score as a screening tool enables credit issuers and other businesses to assess potential fraud risk accompanying new business applicants and therefore respond more quickly and confidently to lower risk new customers.

The fraud risk score is automatically generated by the customer input of application data through a “Name Search” function in conventional access systems. It is calculated and based on several sources of predictive data, including historical search data that match to the customer's input data. The fraud risk score is designed to identify a small percentage of new business applicants that have characteristics and behaviors which are similar to previously identified business frauds.

This empirically derived and statistically validated fraud risk score includes analytical development based on a common definition of business fraud, including a cross-industry set of “bads.” “Bads” is equivalent to 15,000 confirmed frauds and other suspect high risk businesses contributed to the support model development by Fraud Advisory Council members. These are business records wherein businesses either took a loss on or declined to do business with. Alternatively, business fraud can include information from data integration processes, which include predictive data, entity matching and predictive scoring expertise

Advantageously, the fraud risk score is derived from data integration information. In one embodiment, processes including global data collection, entity matching and predictive indicators, and their associated drivers as describe in copending and commonly assigned U.S. patent Publication No. 2004/0162742-A1 (Ser. No. 10/368,072), which is incorporated herein by reference in its entirety, are used to develop the fraud risk score.

Data integration systems incorporate processes that include collecting, aggregating, editing, and verifying data from thousands of sources daily so that customers can use the information to make profitable decisions for their businesses.

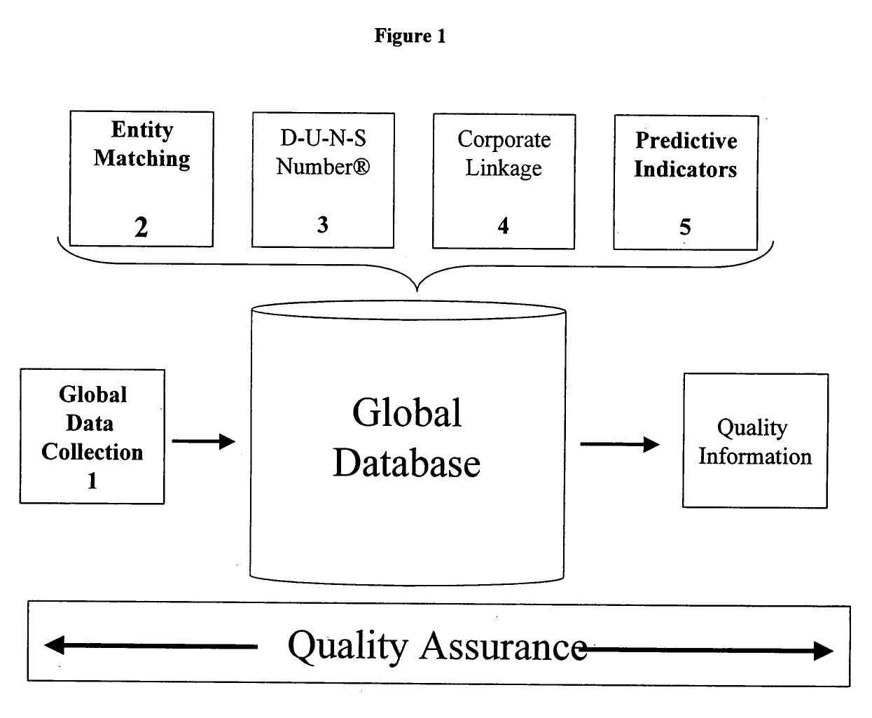

The foundation of such data integration is quality assurance which includes thousands of separate automated checks, plus many manual ones, to ensure the data meets quality standards. In addition, five quality drivers work sequentially to collect and enhance the data, as shown in FIG. 1. Global data collection 1 brings together data from a variety of sources worldwide. Data is integrated into a global database 6 through entity matching 2, which produces a single, more accurate picture of each business. In step 3, a unique corporate identifier, such as a D-U-N-S® Number, is applied as a unique means of identifying and tracking a business globally through every step in the life and activity of the business. A corporate linkage step 4 enables customers to view their total risk or opportunity across related businesses. Lastly, predictive indicators 5 use statistical analysis to rate a business' past performance and to indicate how likely the business is to perform that same way in the future. Data integration information refers to data, including business information data, that has been subjected to at least one or more of the process steps described above.

The fraud risk score is developed by analyzing several types of predictive data and building a segmentation model. Initially an analysis was completed on the predictive lift associated with 10 different sets of variables from 3 different categories. 8 of the 10 sets were found to be predictive. The Fraud Risk Score model can be developed using CART software, a classification and segmentation tool. Terminal nodes are ranked and ordered based on expected performance and the score structure applied. Decisioning rules to reach the terminal nodes can be coded to build the model.

The fraud risk score method includes a step of initially matching applicant identification data to a historical search database, which is a source of credit activity data. The historical search database includes records of searches for business information in one or more databases. For example, these historical search databases contain information on millions of searches regarding credit histories. The historical search database may be updated with various frequencies, such as daily, or is updated in real time. The historical search database retains search information for a selected period of time, such as six months.

Predictive “who”, “what” and “when” patterns are developed for each user indicated in the historical search database. A user, i.e., an applicant, is generally referred to as an entity accessing one or more business information databases. Specific “who”, “what” and/or “when” patterns are analyzed to identify higher levels of fraud risk.

The “who, what, when” developed patterns of an applicant match to the historical search database provide a predictive measure of fraud risk. High fraud risk “who” patterns include abnormally high concentrations of searches within high-risk industries coupled with relatively few searches within lower risk industries. Higher risk “what” patterns include variations in the use of names, addresses and phone numbers within prior searches. Higher risk “when” patterns include abnormally high concentrations of searches within short periods of time, especially with no prior search history.

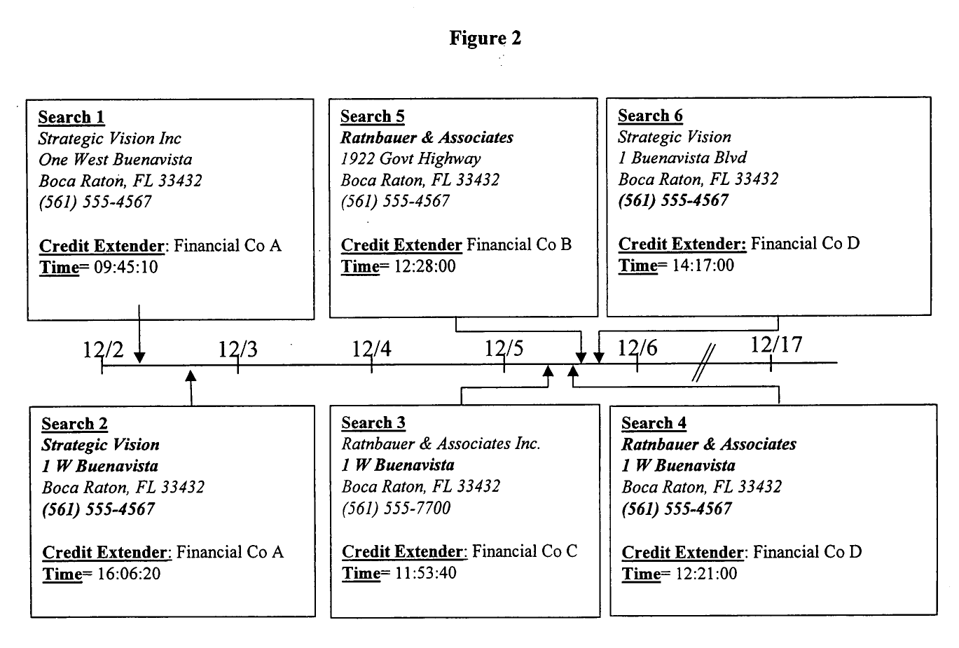

An example of a historical search pattern taken from the historical search database is shown in FIG. 2. In this example, the method shows a total of six searches during the period between December 2 and December 17. As shown in FIG. 2, the user searched for Strategic Vision Inc. on three occasions, and for Ratnbauer & Associates on two occasions. This is an example of how a high risk pattern can be detected, it represents the type of behavior the fraudsters may exhibit in the marketplace as they attempt to perpetrate fraud against multiple companies.

The fraud risk score process also matches an applicant's identification to data in a misrepresentation database. The misrepresentation database includes data on entities that have misrepresented facts to an information provider in the past. Any misrepresented facts can be included, such as identification and contact information, sales information, and financial information.

This misrepresentation database includes names and addresses of business entities that have misrepresented facts to database maintainers in the past. The misrepresentation database is updated periodically, and preferably daily, and adds information on, for example, 1,200 to 1,400 businesses annually. The misrepresentation database typically contains over ten years of information history. Preferably, the misrepresentation database has at least three years of information, as information of up to and around three years of age is considered to be most predictive.

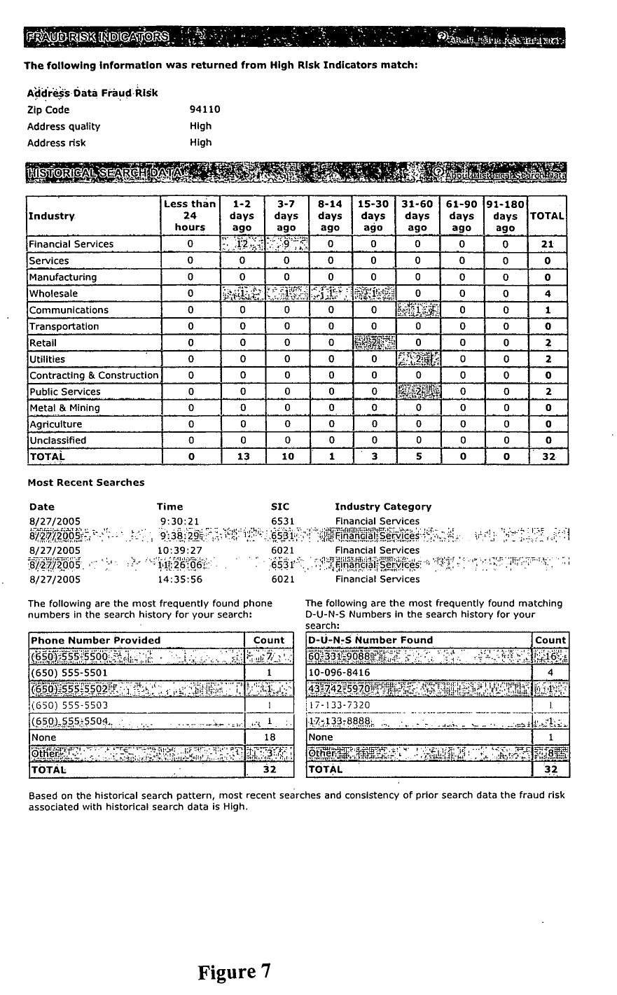

In another step, the fraud risk score process matches applicant data to several additional sources of fraud predictive data called High Risk Identifiers. High Risk Identifiers include address data facts and telephone data facts. Address data facts include the type of address provided (i.e., is it a residence or apartment building), the quality of address information provided (i.e., is it a legitimate address), and the risk of location, e.g., whether higher incidences of fraud occur from given locations. Telephone data facts include the type of carrier and line services originally assigned to the number. High Risk Identifiers could alert a user that the business is physically located in a geographic area that has been previously shown to have a significantly higher business fraud concentration than normal. Similarly, the area code and exchange of the phone number might match to a list of AC/Exchanges that show increased risk. FIG. 7 illustrates a portion of a fraud risk score report showing an example of a match derived from a source of High Risk Identifiers.

In a further step, attributes and applicant data matches from the above-mentioned sources are analyzed and scored to produce a fraud risk score. The fraud risk score provides a numerical indicator indicative of a risk that the applicant may commit a fraud. The numerical indicator is preferably part of a range of numerals, which may further be broken up into risk classes.

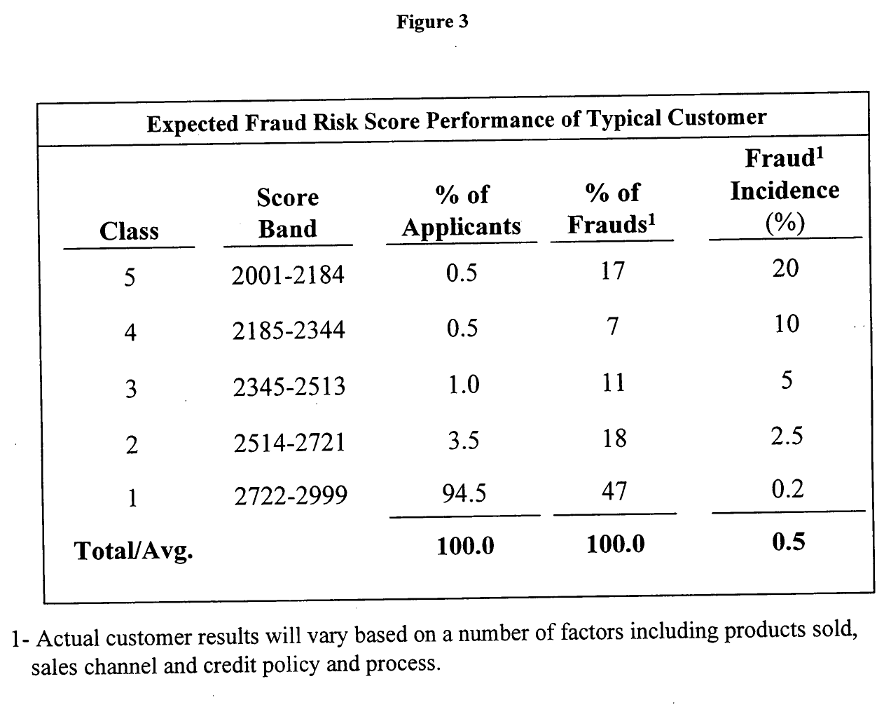

In a preferred embodiment, the fraud risk score is a numerical value between 2001 and 2999. The numerical values are broken up into risk classes. Exemplary classes relating to various score ranges are shown in FIG. 3 discussed below. For example, a class 1 fraud risk, corresponding to the lowest risk of fraud, is assigned to an entity having a fraud risk score in the range of 2722-2999. Similarly, a class 5 fraud risk, corresponding to the highest risk of fraud, is assigned to an entity having a fraud risk score in the range of 2001 to 2184, as illustrated by FIG. 3.

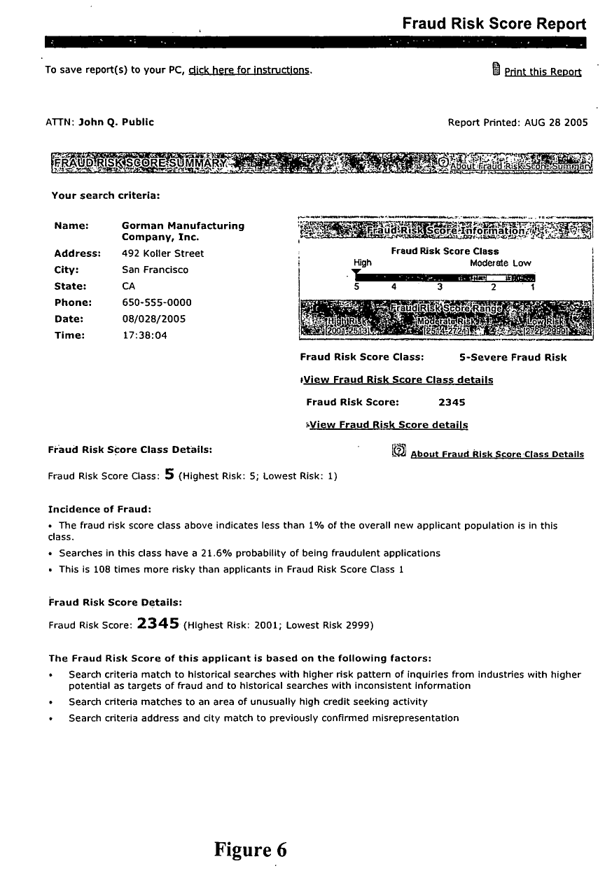

FIG. 6 illustrates a portion of a fraud risk score report showing a fraud risk score summary. The fraud risk score summary includes a fraud risk score and a risk class. For example, the fraud risk score shown in FIG. 6 is 2345, which corresponds to a fraud risk score class of 5, indicating a high risk of fraud. In another preferred embodiment, score reason codes, and attributes including a historical search data match profile may also be provided to a user in addition to the fraud risk score. Examples of score reasons codes are shown in FIG. 6, and an examples of a historical search data match profile is shown in FIG. 7. These additional features enable the user to understand the reason(s) for the elevated risk, provide additional data for further precision and segmentation and in general can support the determination of next steps to be taken in their evaluation process.

The fraud risk score has been validated through retrospective testing as shown by the resultant table of fraud incidents among entities, as compared to their assigned fraud risk score. The table, entitled “Expected Fraud Risk Score Performance of Typical Customer”, is shown in FIG. 3.

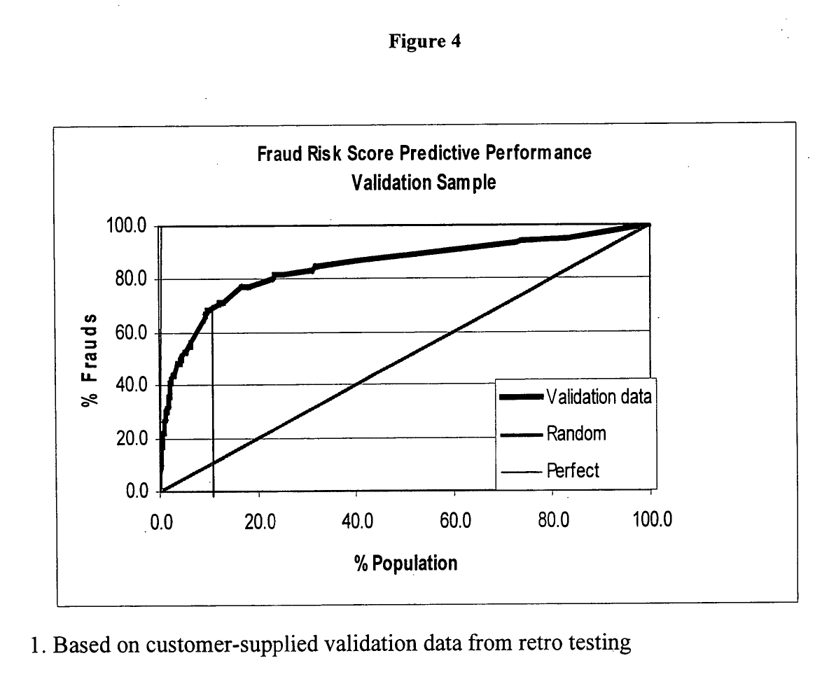

The performance of the fraud risk score has been shown to be highly effective, as over 65% of fraud risk has been shown to be in the 10% of the population producing the highest risk scores. The graph shown in FIG. 4, entitled “Fraud Risk Score Predictive Performance Validation Sample”. Validation data is a data plot line demonstrating that 65% of the frauds are found at 10% of the population. The Random selection line is shown as the straight diagonal line. Using a random selection approach customers would identify 10% of the frauds at a 10% review rate. The “Perfect” line, shown as a nearly vertical line, assumes the customer could identify every fraudulent application. The spread between the Random line and the Fraud Risk Score performance line is one measure of the predictive “lift” of the score. This difference in performance is the gain a customer would achieve by using the score to select applications for review versus a random sampling of applications. This graph demonstrates that the FRS will enable users to efficiently prevent fraud.

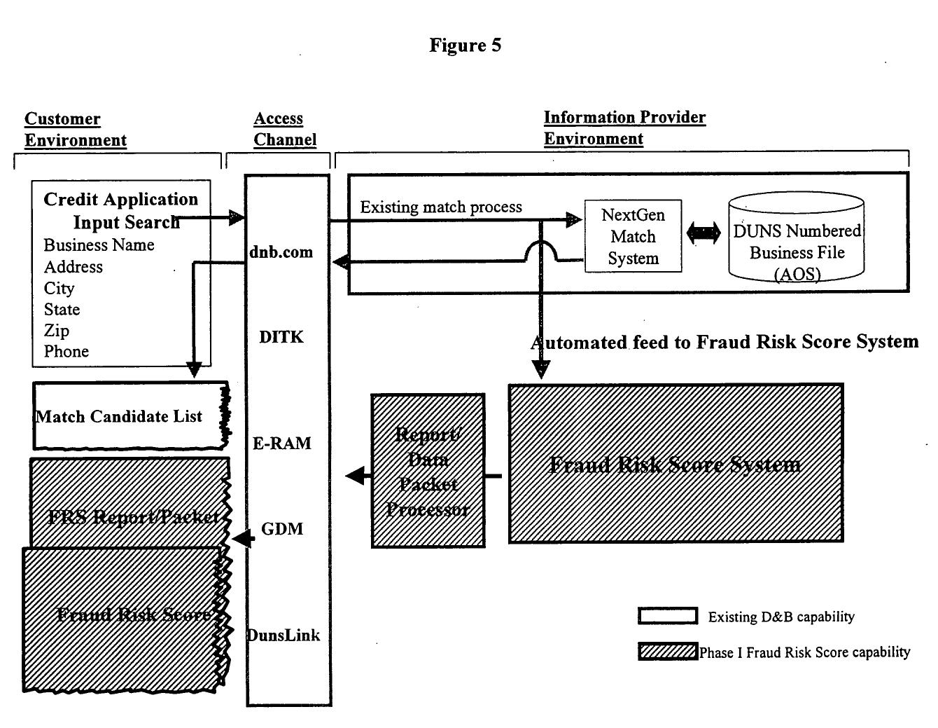

FIG. 5 demonstrates the ease in which the fraud risk score system and method can be integrated into existing entity matching and validation processes. Referring to FIG. 5, a customer can enter a business name and contact information to retrieve credit information or other information about the business entity, provided by an information provider. The customer can interact or interface with the information provider via access channels including a web site, a data integration toolkit, a risk assessment manager, a global decision maker, or other connection platforms provided by an information provider.

The matching system utilizes the inputted business entity information, via an existing or next generation match process, to provide further information about the business entity. The matching process is further enhanced by assigning or matching business data to a unique business or corporate identifier.

The matching system automatically feeds the business information to the fraud risk score (FRS) system, which incorporates business matching information and FRS information into an information packet which is then delivered to the customer.

Preferably, the fraud risk score and any additional information is delivered to a user via a computing platform. Preferably, the user interfaces the fraud risk score system through a web-based platform. The fraud risk system is preferably a computer system, including components such as one or more computing workstations, containing a memory and a processor for collecting and analyzing data according to the above method. Components such as the processor are in communication with various databases, including databases for producing data integration information and/or databases such as historical search databases, misrepresentation databases and high risk identifier databases.

Information considered to be predictive of fraud includes confirmed frauds, first payment default and write-offs, identity thefts and unauthorized use (i.e., it refers to unauthorized use of a commercial credit card by an employee). The database is preferably searchable by business entity names, addresses and/or telephone numbers.

It should be understood that various alternatives, combinations and modifications of the teachings described herein could be devised by those skilled in the art. The present invention is intended to embrace all such alternatives, modifications and variances that fall within the scope of the claims that follow.

The invention claimed is:

1. A computer-implemented method for providing a predictive measure of fraud risk, the method comprising:
receiving applicant identification data;
identifying predictive fraud patterns by matching the applicant identification data to a historical search database;
calculating a predictive measure of fraud risk using the predictive fraud patterns; and
providing the predictive measure of fraud risk to a user via a report or display.

2. The method of claim 1, wherein the historical search database comprises credit activity data.

3. The method of claim 1, wherein the historical search database is updated in real time.

4. The method of claim 1, wherein the step of identifying predictive fraud patterns comprises analysis of at least one factor selected from the group consisting of: the industry from which the search was made; variations in the use of names, addresses and phone numbers within prior searches; timing of searches made; and frequency of searches made.

5. The method of claim 1, wherein the step of identifying predictive fraud patterns further comprises matching the applicant identification data to a database of prior business misrepresentations.

6. The method of claim 5, wherein the database of prior business misrepresentations comprises names and addresses of entities that have misrepresented facts to an information provider in the past.

7. The method of claim 1, wherein the step of identifying predictive fraud patterns further comprises matching the applicant identification data to a source of high risk identifiers.

8. The method of claim 7, wherein the high risk identifiers is at least one selected from the group consisting of: address data facts and telephone data facts.

9. The method of claim 8, wherein the address data facts is at least one selected from the group consisting of: the type of address provided, the quality of address information provided, and the risk associated with the address location.

10. The method of claim 8, wherein the telephone data facts is at least one selected from the group consisting of: the type of carrier and line services originally assigned to the number.

11. The method of claim 1, wherein the step of providing the predictive measure of fraud risk to a user comprises providing a numerical indicator indicative of a risk that an applicant may commit a fraud.

12. The method of claim 11, wherein the numerical indicator ranges in value between about 2001 and about 2999.

13. The method of claim 11, further comprising:
breaking up the numerical indicator into a plurality of ranges;
assigning a risk class to each of the plurality of ranges; and
providing an indicator of risk class to a user.

14. The method of claim 11, further comprising providing score reason codes to a user.

15. The method of claim 1, further comprising providing a historical search data match profile to a user.

16. A computer-implemented method for providing a predictive measure of fraud risk, the method comprising:
receiving identification data for an applicant;
identifying predictive fraud patterns by matching the identification data to a historical search database;
matching the identification data to a database of prior business misrepresentations;
matching the identification data to a source of high risk identifiers;
calculating a predictive measure of fraud risk based on at least one selected from the group consisting of: the predictive fraud patterns, the degree of match between the identification data and the database of prior business representations, and the degree of match between the identification data and the source of high risk identifiers; and
providing the predictive measure of fraud risk to a user via a report or display.

17. A system for providing a fraud risk score comprising:
an interface for receiving applicant identification data;
a first database comprising records of searches for business information in at least one other database;
an evaluator, wherein the evaluator receives the applicant identification data from the interface and calculates a predictive measure of fraud risk by matching the applicant identification data to the records in the first database to identify predictive fraud patterns and produce a fraud risk score;
an output for providing the fraud risk score to a user via a report or display.

18. The system of claim 17, further comprising a second database comprising names and addresses of business entities that have misrepresented facts to database maintainers in the past; wherein the evaluator matches the applicant identification data to the second database and adjusts the predictive measure of fraud risk according to the degree of match.

19. The system of claim 17, further comprising a third database comprising high risk identifiers; wherein the evaluator matches the applicant identification data to the third database and adjusts the predictive measure of fraud risk according to the degree of match.

20. The system of claim 17 wherein the fraud risk score is delivered to a user via a computing platform.

21. The system of claim 20 wherein the computing platform is a web-based platform.
